(19) United States
(12) Patent Application Publication
(10) Pub. No.: US 2009/0203405 A1
(43) Pub. Date: Aug. 13, 2009

(54) Data transmission method, base station and user transceiver

(75) Inventors: Kari Horneman, Oulu (FI); Jyri K. Hamalainen, Oulu (FI)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Nokia Corporation

(21) Appl. No.: 12/309,133

(22) PCT Filed: Jul. 11, 2006
(86) PCT No.: PCT/FI2006/050333

§ 371 Date: Jan. 8, 2009

(51) Int. Cl. H04M 1/00; H04B 7/06

(52) U.S. Cl. 455/562.1; 342/377; 342/375

(57) ABSTRACT

A multicarrier data transmission method and a base station (200) are provided. The base station comprises an antenna arrangement (204 to 208) configured to form multiple antenna beams, and a first controller (800) configured to divide subcarriers of the multicarrier transmission into more than one subcarrier group and allocate each subcarrier group to an antenna beam, and a second controller (238) configured to control the antenna beams formed by the antenna arrangement during transmission to sweep constantly over a given area at a constant mean beam specific angular velocity.

### FIELD

The invention relates to data transmission in a telecommunication system. In particular, the invention relates to solutions utilising multicarrier transmission and multiple antenna beams.

### BACKGROUND

Communication systems, and wireless communication systems in particular, have been under extensive development in recent years. In addition to the conventional speech transmission, several new services have been developed. Different data and multimedia services are attractive to users, and communication systems should provide sufficient quality of service at a reasonable cost.

The new developing services require high data rates and spectral efficiency at a reasonable computational complexity. The proposed solutions include multicarrier transmission and multiple-input-multiple-output (MIMO) solutions utilising multiple transmit and receive antennas. Multicarrier transmission may be realised with several methods, of which orthogonal frequency division multiplexing (OFDM) is the most common. MIMO systems usually utilise beam-forming. The upcoming systems designed to enhance and replace the present UMTS (Universal Mobile Telecommunication System) are likely to utilise the above-mentioned methods. The systems being designed will use only packet switched transmission. Thus, packet scheduling will play an important role.

Generally, beam-forming is realised either with fixed beam-forming or user beam-forming. In fixed beam-forming, a fixed number of beams is provided and data is transmitted using all the beams at the same time. In user beam-forming, the users' positions are detected and the beams are pointed towards the users. The second method is more complex than the first one.

A variant of beam-forming is called opportunistic beam-forming. In opportunistic beam-forming, beams are randomly directed towards users in such a manner that within a given time period the whole coverage area is covered. The purpose is to serve users in the coverage area evenly so that the average waiting time for each user is the same. An advantage of opportunistic beam-forming is that the service may be carried out with a low complexity since no need exists to know where the users are. Random directivity of the beams guarantee that a beam is points at any given user sooner or later.

An example of the opportunistic beam-forming technique is described by Viswanath P., Tse, D. N. C., Laroia, R. in “Opportunistic beamforming using dumb antennas”, IEEE Transactions on Information Theory, Vol. 48, no. 6, June 2002.

A problem in opportunistic beam-forming with packet scheduling is that it is impossible to determine a fixed retransmission time for packets since a user's serving period is random by nature. The retransmission time is an important parameter in connection with a delay sensitive transmission.

### BRIEF DESCRIPTION OF THE INVENTION

An object of the invention is to provide an improved data transmission solution providing high data rates and spectral efficiency at a reasonable computational complexity. Another object of the invention is to provide a solution combining fixed and opportunistic beam-forming with multicarrier transmission. According to an aspect of the invention, there is provided a multicarrier data transmission method in a telecommunication system, the transmission utilising multiple antenna beams. The method comprises dividing subcarriers of the multicarrier transmission into more than one subcarrier group, allocating each subcarrier group to an antenna beam, controlling the antenna beams during transmission to circulate around at a constant mean beam specific angular velocity.

According to another aspect of the invention, there is provided a multicarrier data transmission method in a telecommunication system, the transmission utilising multiple antenna beams. The method comprises dividing subcarriers of the multicarrier transmission into more than one subcarrier group, allocating each subcarrier group to an antenna beam, controlling the antenna beams during transmission to sweep constantly over a given area at a constant mean beam specific angular velocity.

According to another aspect of the invention, there is provided a base station utilising multicarrier transmission in a telecommunication system, comprising an antenna arrangement configured to form multiple antenna beams, the base station comprising a first controller configured to divide subcarriers of the multicarrier transmission into more than one subcarrier group and allocate each subcarrier group to an antenna beam, and a second controller configured to control the antenna beams formed by the antenna arrangement during transmission to circulate around at a constant mean beam specific angular velocity.

According to another aspect of the invention, there is provided a base station utilising multicarrier transmission in a telecommunication system, comprising an antenna arrangement configured to form multiple antenna beams, the base station comprising a first controller configured to divide subcarriers of the multicarrier transmission into more than one subcarrier group and allocate each subcarrier group to an antenna beam, and a second controller configured to control the antenna beams formed by the antenna arrangement during transmission to sweep constantly over a given area at a constant mean beam specific angular velocity.

According to another aspect of the invention, there is provided a telecommunication system utilising multicarrier transmission, comprising a base station utilising an antenna arrangement configured to form multiple antenna beams, the base station of the system comprising a first controller configured to divide subcarriers of the multicarrier transmission into more than one subcarrier group and allocate each subcarrier group to an antenna beam, and a second controller configured to control the antenna beams during transmission to circulate around at a constant mean beam specific angular velocity.

According to another aspect of the invention, there is provided an integrated circuit, configured to divide subcarriers of a multicarrier transmission into more than one subcarrier group and allocate each subcarrier group to an antenna beam, control the antenna beams formed by an antenna arrangement during transmission to sweep constantly over a given area at a constant mean beam specific angular velocity.

According to another aspect of the invention, there is provided a computer program product encoding a computer program of instructions for executing a computer process for a multicarrier data transmission, the transmission utilising multiple antenna beams, the process comprising: dividing subcarriers of the multicarrier transmission into more than one subcarrier group, allocating each subcarrier group to an antenna beam, controlling the antenna beams during transmission to sweep constantly over a given area at a constant mean beam specific angular velocity.

According to yet another aspect of the invention, there is provided a computer program distribution medium readable by a computer and encoding a computer program of instructions for a multicarrier data transmission, the transmission utilising multiple antenna beams, the process comprising: dividing subcarriers of the multicarrier transmission into more than one subcarrier group, allocating each subcarrier group to an antenna beam, controlling the antenna beams during transmission to sweep constantly over a given area at a constant mean beam specific angular velocity.

According to yet another aspect of the invention, there is provided a user transceiver in a telecommunication system. The user transceiver is configured to receive information about subcarriers of multicarrier transmission allocated to the user transceiver and information about antenna beam control parameters controlling the antenna beams to sweep constantly over a given area at a constant mean beam specific angular velocity.

Embodiments of the invention provide several advantages. The proposed solution may be implemented with the same complexity as fixed beamforming. However, it offers virtually the same benefits as opportunistic beamforming. No need exists to determine positions of users. Since the angular velocities of the beams are known, a fixed retransmission time may be determined in connection with packet scheduling.

### LIST OF DRAWINGS

In the following, the invention will be described in greater detail with reference to the embodiments and the accompanying drawings, in which

FIG. 1 illustrates an example of a telecommunication system to which embodiments of the invention are applicable;

FIGS. 2A and 2B illustrate a system model of a beam-forming concept,

FIG. 3 is a flowchart illustrating an embodiment of the invention,

FIG. 4 illustrates an example of division of subcarriers to subcarrier groups,

FIG. 5 illustrates an example of allocation of subcarrier groups to antenna beams,

FIG. 6 illustrates an example of transmission and control of antenna beams,

FIG. 7 illustrates another example of control of antenna beams, and

FIG. 8 illustrates an example of a base station.

### DESCRIPTION OF EMBODIMENTS

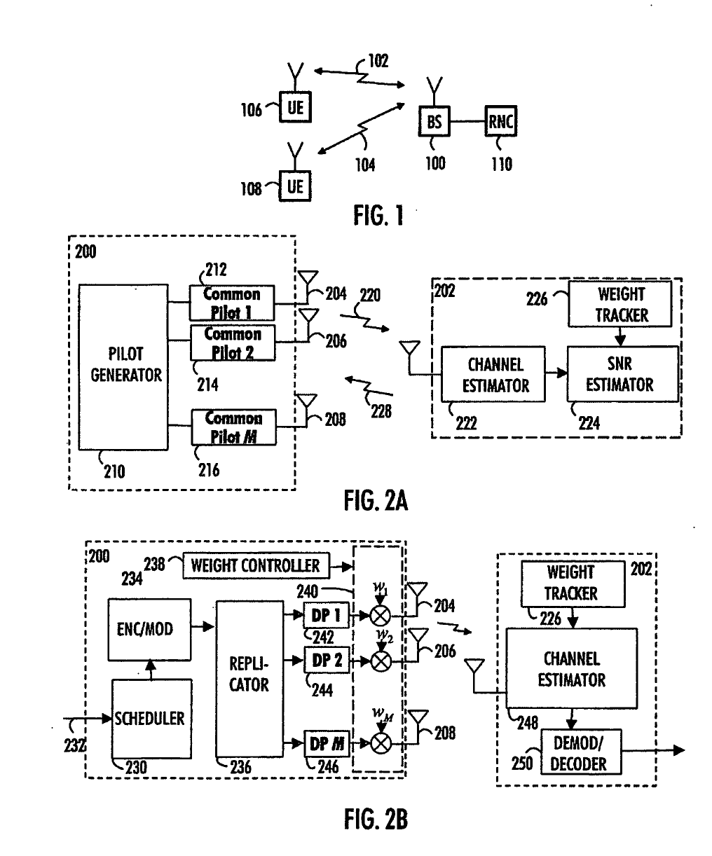

With reference to FIG. 1, examine an example of a telecommunication system to which embodiments of the invention are applicable. The system in FIG. 1 represents a cellular telecommunication system such as UMTS. The embodiments are, however, not restricted to these telecommunication systems described by way of example, but a person skilled in the art can apply the instructions to other telecommunication systems containing corresponding characteristics. The embodiments of the invention can be applied, for example, to future Broadband Wireless Access (BWA), 3GPP LTE (Long Term Evolution) and 4G systems or other systems designed to enhance or replace UMTS, or WIMAX (Worldwide Interoperability for Microwave Access) type of systems.

FIG. 1 is a simplified part of a cellular telecommunication system, which comprises a base station or an equivalent network element 100, which has bi-directional radio links 102 and 104 to user transceivers 106 and 108. The user transceivers may be fixed, vehicle-mounted or portable. The base station comprises transceivers which are able to establish the bi-directional radio links to the user transceivers. The base station is further connected to a radio network controller or an equivalent network element 110, which transmits the connections of the transceivers to the other parts of the network. The radio network controller controls in a centralized manner several base stations connected to it.

The cellular radio system can also communicate with other networks, such as a public switched telephone network, or the Internet.

Embodiments of the invention utilise beam-forming. FIGS. 2A and 2B illustrate a system model of a beamforming concept. FIGS. 2A and 2B illustrate a base station 200 and a user transceiver 202. The figures are simplified for clarity. One skilled in the art knows that base stations and user transceivers may comprise other parts not illustrated in FIGS. 2A and 2B.

FIG. 2A illustrates estimation of ac signal-to-noise ratio executed by the user transceiver 202 during each scheduling time interval. The exemplary system structure can be applied both to uncorrelated and correlated transmit antennas. The base station 200 comprises multiple antennas 204, 206, 208 configured to transmit a signal 220 from each antenna to the user transceiver 202. In diversity transmission, an exactly same signal is transmitted from each antenna. However, in a capacity MIMO, different signals (or streams) are transmitted from antennas. In a beam-forming case, different streams are transmitted to each beam and they formed by an antenna array. The base station further comprises a unit for generating orthogonal pilots 210 and common pilot units 212, 214, 216. A common/dedicated pilot structure 212, 214, 216 similar to UTRA FDD (UMTS terrestrial radio access, frequency division duplex) may be utilised. A common pilot is transmitted cell-wise and a dedicated pilot is transmitted antenna-wise, as described in connection with FIG. 2B. The use of dedicated pilots is, however, optional.

The user transceiver 202 comprises a channel estimation unit 222 and a signal-to-noise ratio calculation unit 224 where an overall signal-to-noise ratio is monitored. Feedback 228 about the signal-to-noise ratio is then transmitted back to the base station 200. The feedback is utilised when transmitting actual data from the base station 200 to the user transceiver 202.

FIG. 2B illustrates the actual data transmission.

In the presented solution, transmit weights w₁, w₂, w_{M} are applied on data channels. A signal to be transmitted from each antenna 204, 206, 208 of the base station 200 is multiplied with a weight factor in a multiplier unit 240. The antenna transmit weights are changed using weight sequences. Both the base station 200 and the user transceiver 202 are equipped with transmit weight information. Thus, both ends know the sequence of the transmit weights. The information on the transmit weight sequences can be provided to the user transceivers, for example, in the following manner: a user transceiver requests a certain service from a base station when a packet connection is being initialised. The number or another indicator of the applied transmit weight sequence is sent to the user transceiver if the service is granted, and the user transceiver recalls a transmit weight vector corresponding to the sequence number from a user transceiver memory (alternative weight sequences can be stored in the user transceiver memory beforehand). A weight tracker 226 can control functions relating to recalling the transmit weight vectors or calculating them on the basis of the number or some other indicator of the applied transmit weight sequence.

Since the transmit weight vector sequences may be long, the user transceiver 200 may also know the number of the transmit weight in the sequence for a certain scheduling time interval. This information can be made available on a downlink broadcast control channel. Such a number can also be given when initialising the connection.

The base station of FIG. 2B comprises a scheduling/data buffer unit 230 configured to control scheduling decisions of data streams 228 on the basis of the feedback 228 received from the user transceiver 202. If a transmit decision is made, a data stream is transmitted via an encoder/modulator unit 234 to a replication unit 236 that forms signal replicas of a data stream for transmission. Further, a weight control unit 238 controls the transmit weights w₁, w₂, w_{M} of different antennas 204, 206, 208. Dedicated pilots 242, 244, 246 may be added to the signals to be transmitted. Each antenna signal may have a different dedicated pilot. However, the use of dedicated pilots is optional. The same procedure is performed on each transmitted data stream.

The user transceiver 200 receives one or more transmitted data streams and the data is processed in a channel estimator unit 248 and in a demodulation/decoding unit 250. A weight tracker 226 provides the transmit weights.

As stated in connection with FIG. 2A, orthogonal common pilots are applied to M antennas 204, 206, 208 for enabling the estimation of channels between the user transceiver and the M transmit antennas 204, 206, 208. After the channel estimation from a common pilot channel in a channel estimation unit 222, the user transceiver 202 can compute the expected signal-to-noise ratios corresponding to any future scheduling time interval by applying the transmit weight sequences. The signal-to noise ratios can be calculated in the SNR calculation unit 224.

Thus, with the help of common pilots and known transmit weight vector patterns, the receiver can in advance: estimate signal-to-noise ratios corresponding to future transmit time intervals, order or process in some other ways the resulting signal-to-noise ratios and decide—based on service data rate and delay requirements—suitable transmit time interval/signal-to-noise ratio pairs.

Since the transmit weights are known in the user transceiver, the channel estimation can be carried out on the basis of the common pilots or jointly on the basis of both common and dedicated pilots. Since the user transceiver knows the transmit weights of the next scheduling time interval in advance, the transceiver can estimate the signal-to-noise ratio corresponding to the next scheduling time interval efficiently by using the latest channel information (estimated from common pilots). The base station then has the relevant SNR information at the beginning of each scheduling time interval, and the performance of the scheduling procedure remains robust, i.e. the base station can transmit data to user transceivers in good receiving conditions.

In case of low mobility and delay tolerant services, the user transceiver does not have to send SNR feedback during each scheduling time interval if the detected SNR is low. Occasional feedback can be conveyed in uplink packet channels such as a random access channel.

In extreme cases of stationary channel or highly correlated antennas, the user transceiver knows the most suitable transmit weights long before they are applied in the base station. The user transceiver can then switch off reception during waiting times. Further, depending on the signal-to-noise ratio estimations and service needs, the user transceiver can suspend the feedback 228 transmission when necessary. When dedicated data transmission arrives, the user transceiver can utilize both common and dedicated pilots in joint channel estimation. This enables robust data detection.

The signal-to-noise ratio corresponding to the next scheduling time interval can now be reliably estimated. This improves the scheduling performance at the beginning of each scheduling time interval. Channel estimation is more robust since filtering techniques can be utilized better (channel fluctuations due to the changes in transmit weights can be taken into account better). A need for feedback capacity is smaller since feedback transmission can be suspended from time to time. It is possible to shut off the user transceiver receiver from time to time if the channel is stationary or the transmit antennas admit high mutual correlation.

Embodiments of the invention utilise multicarrier transmission. In multicarrier transmission, a desired signal is transmitted using several frequencies, which are usually called subcarriers. Multicarrier transmission may be realised with several methods, of which orthogonal frequency division multiplexing (OFDM) is the most common.

In an embodiment of the invention, the subcarriers of the multicarrier transmission are divided into more than one subcarrier group. The subcarriers of the multicarrier transmission may be divided into more than one subcarrier group on the basis of the transmission capacity and quality of service (QoS) required by the users served by the base station. In an embodiment, the number of different available modulation and coding combinations are taken into account when selecting the number and size of subcarrier groups. In an embodiment, channel quality information is utilised when selecting the number of different subcarrier groups.

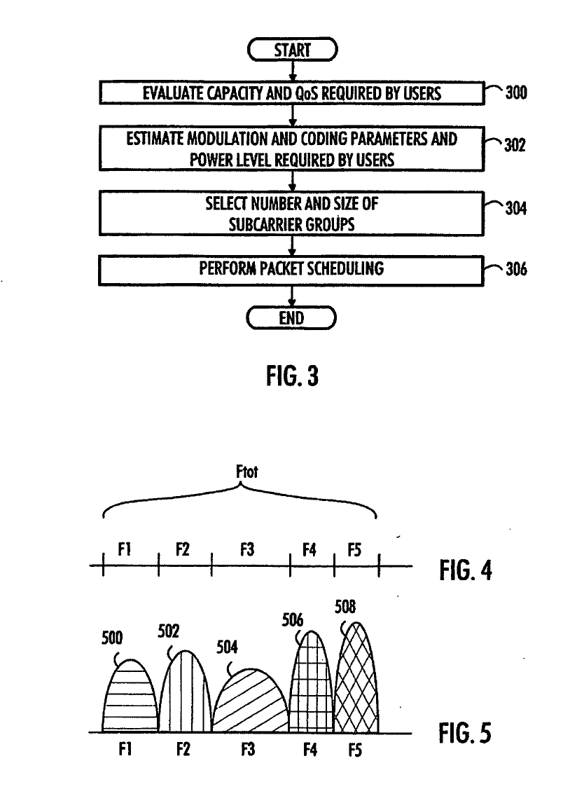

FIG. 3 is a flowchart illustrating an embodiment of the invention. In step 300, the transmission capacity and quality of service required by the users served by the base station are evaluated.

In step 302, the modulation and coding parameters and power level required by each user are estimated. Channel quality information received from the user transceivers may be taken into account when determining these values.

In step 304, the required number of subcarrier groups and the number of subcarriers in each group are selected. The number of subcarriers in a group may vary from group to group.

In step 306, the data transmissions of the users of the user transceivers are allocated to the subcarrier groups (i.e. packet scheduling is performed).

In an embodiment, the number and size of subcarrier groups are based on the transmission capacity and quality of service required by the users. The modulation, coding and power level parameters are determined during packet scheduling. In addition, properties and capabilities of transceivers of users may be taken into account.

In an embodiment, the number of subcarrier groups is based on the number of the different modulation and coding combinations (for example QPSK ½, QPSK ⅓, QPSK ⅕, QAM 16½, QAM ⅓, where the latter number is the coding rate) available in the base station. In an embodiment, the number of subcarrier groups is larger than the number of different modulation and coding combinations. In that case, different power levels may be utilised for the same modulation and coding combinations.

In an embodiment, the number and size of subcarrier groups are fixed.

Thus, as different services used by the users have different transmission capacity needs and different QoS requirements, the allocation of subcarrier groups may be tailored to meet the needs of the users. On the other hand, users may be equipped with transceivers with different properties and capabilities. This may affect the selection of modulation and coding parameters and the available power level choices.

FIG. 4 illustrates an example of the division of subcarriers to subcarrier groups. F_{TOT} is the total allocated frequency band. In this example the allocated frequency band is divided into five subcarrier groups, F1, F2, F3, F4 and F5. All subcarrier groups are not equal in size. Thus, the number of subcarriers in each group is not necessarily the same.

In the above example, subcarriers that belong to the same group reside adjacent to each other. This corresponds to a localized frequency resource use. However, the subcarriers may also be distributed freely on the frequency axis. The subcarriers belonging to a same group need not be adjacent to each other. This corresponds to a distributed frequency resource use.

In an embodiment of the invention, each subcarrier group is allocated to an antenna beam, and the transmission of the antenna beams is controlled such that the antenna beams are to sweep constantly over a given area at a constant beam specific angular velocity during the transmission. The direction of the antenna is controlled by the transmit antenna weights w₁, w₂, w_{M} where M is the number of antennas.

FIG. 5 illustrates an example of allocation of subcarrier groups F1, F2, F3, F4 and F5 to antenna beams. Each subcarrier group is allocated to a separate antenna beam. Subcarrier group F1 is allocated to a beam 500, subcarrier group F2 is allocated to a beam 502, group F3 to a beam 504, group F4 to a beam 506, and group F5 to a beam 508.

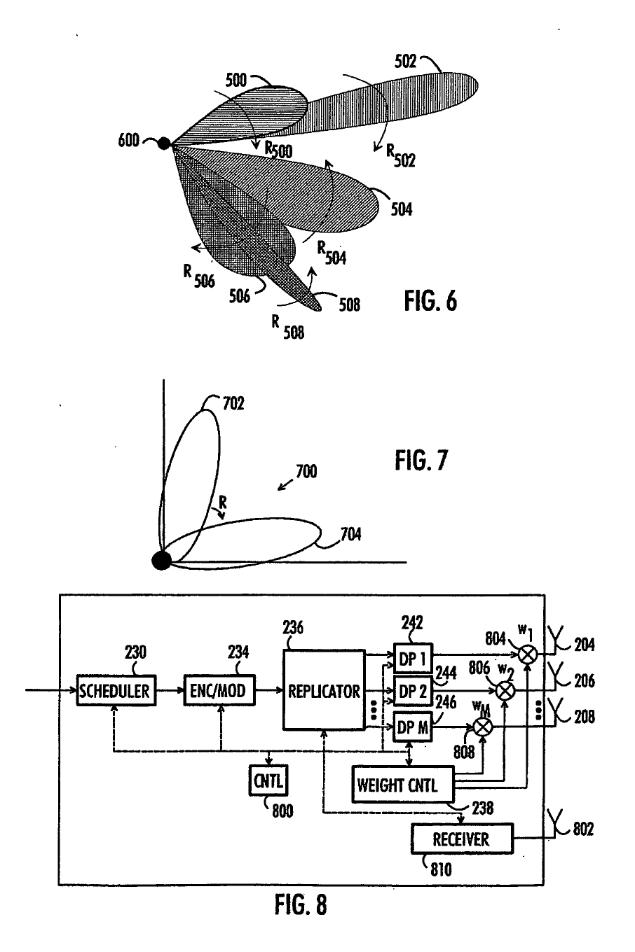

FIG. 6 illustrates an example of transmission and control of antenna beams in a base station 600. Antenna beams 500 to 508 are transmitted from the base station 600. The transmission of the antenna beams is controlled such that each beam i rotates around at a constant beam specific angular velocity Rᵢ. Thus, the beam 500 rotates around the base station 600 at an angular velocity R₅₀₀. Correspondingly, beam the 502 circulates around the base station at an angular velocity R₅₀₂, the beam 504 circulates at an angular velocity R504, the beam 506 circulates at an angular velocity R₅₀₈ and the beam 508 circulates around the base station 600 at an angular velocity R₅₀₈. The direction of rotation may vary depending on the beam. In the example of FIG. 6, the beams 500 to 506 rotate clockwise while the beam 508 rotates anticlockwise.

In an embodiment of the invention, the beams rotate around the base station 600. In another embodiment, the beams sweep constantly over a given area, such as a sector. FIG. 7 illustrates such an embodiment. FIG. 7 shows a base station 600 and a 90-degree sector 700. The base station transmits a beam, which sweeps over the sector 700 at a constant angular velocity R. The beam starts sweeping from position 702, and sweeps at a constant velocity until position 704 is reached. Then, the sweeping starts again from position 702.

In an embodiment, the beams rotate or sweep at a constant mean angular velocity. The velocity may have a given variance around a mean value. The angular velocity may have a random fluctuation around the mean value, the fluctuation being defined by the variance. Thus, a random element may be introduced into the rotation of the beams. If the variance is set to zero, the rotation has a constant angular velocity.

Beam widths may be controlled beam-wise. Thus, the coverage area of each beam may be different for each beam. With a narrow beam, a high gain but a smaller coverage area is achieved. A wider beam provides a smaller gain but a larger coverage area. There may be several factors which may be taken into account when selecting the angular velocity and width for each beam. The selection may be based on the required transmission capacity, required delay parameters and the interference level in the coverage area of the beams, for example.

There may be common or dedicated downlink control information that is not included in the dedicated data packets of users' data streams. In an embodiment, this kind of information may be transmitted continuously to the whole coverage area or specific control beams may be utilised for transmitting downlink control information. The control beams may rotate or sweep at a constant mean angular velocity. A benefit of the control beams is that it lowers the total interference level in user transceivers as the transmission at any given time is only towards a given direction and not to the whole coverage area.

Control beams may be defined such that the circulating times of the beams is known in base stations and user transceivers. A control beam may cover the whole coverage area if it carries common broadcast type information, for example. In some embodiments, the coverage area may be smaller. Since the delay in receiving the control information is defined by the angular velocity and the area the beam covers it is possible to use more than one control beam, each having a different circulating time period.

FIG. 8 illustrates an example of a base station to which embodiments of the invention are applicable. The base station 200 comprises M antennas 204, 206, 208. The signal of each antenna is weighted in multipliers 804, 806, 808 with transmit weights w₁, w₂, w_{M}. The weight factors determine the widths and directions of antenna beams transmitted by the antennas 204, 206, 208. The transmit weights are controlled by a controller 238 of the base station 200. The usage of weights to control the transmission of antenna beams is known to one skilled in the art.

The base station 200 may comprise another controller 800 which controls the operation of the base station. The base station 200 comprises a scheduling/data buffer unit 230, an encoder/modulator unit 234 and a replication unit 236 that that forms signal replicas of a data stream for transmission. Dedicated pilots 242, 244, 246 may be added to the signals to be transmitted. The base station comprises a receiver 810 which is configured to receive signal transmitted by user transceivers with an antenna 802. In practice, the same antennas 204, 206, 208 that are used for transmission may also be used for reception.

The signals received from the user transceivers comprise SNR feedback. The feedback is utilised by the controller 800 and the scheduling/data buffer unit 230 as described in connection with FIG. 2B.

In practice, the controllers 238 and 800 may be realised with a single controller, a processor and associated software or discrete components and associated logic. The controllers 238 and 800 may also be realised on an integrated circuit. The controller or controllers may be configured to perform at least some of the steps described in connection with the flowchart of FIG. 3 and in connection with FIGS. 2 to 8. The embodiments may be implemented as a computer program comprising instructions for executing a computer process for multicarrier data transmission which utilises multiple antenna beams. The process comprises: dividing the subcarriers of the multicarrier transmission into more than one subcarrier group, allocating each subcarrier group to an antenna beam, controlling the antenna beams during transmission to circulate around at a constant mean beam specific angular velocity.

The computer program may be stored on a computer program distribution medium readable by a computer or a processor. The computer program medium may be, for example but not limited to, an electric, magnetic, optical, infrared or semiconductor system, device or transmission medium. The computer program medium may include at least one of the following media: a computer readable medium, a program storage medium, a record medium, a computer readable memory, a random access memory, an erasable programmable read-only memory, a computer readable software distribution package, a computer readable signal, a computer readable telecommunications signal, computer readable printed matter, and a computer readable compressed software package.

Even though the invention has been described above with reference to an example according to the accompanying drawings, it is clear that the invention is not restricted thereto but it can be modified in several ways within the scope of the appended claims.

1-41. (canceled)

42. A method, comprising:
utilizing multiple antenna beams in transmission,
dividing subcarriers of a multicarrier transmission into more than one subcarrier group,
allocating each subcarrier group to an antenna beam, and
controlling the antenna beams during transmission to circulate around at a constant mean beam specific angular velocity.

43. The method of claim 42, further comprising: dividing the subcarriers of the multicarrier transmission into more than one subcarrier group on the basis of the number of different available modulation and coding combinations.

44. The method of claim 42, further comprising: dividing the subcarriers available for use in a base station into more than one subcarrier group.

45. The method of claim 44, further comprising: dividing the subcarriers of the multicarrier transmission into more than one subcarrier group on the basis of transmission capacity and quality of service required by users served by the base station.

46. The method of claim 42, further comprising: utilizing channel quality information when selecting the number of different subcarrier groups.

47. The method of claim 42, further comprising: controlling widths of the antenna beams beam-specifically.

48. The method of claim 42, further comprising: allocating users to the subcarriers on the basis of the transmission capacity and quality of service required by the users.

49. The method of claim 42, further comprising: taking into account an interference level in a coverage area of the beams when selecting the angular velocity of each beam.

50. The method of claim 47, further comprising: taking into account an interference level in a coverage area of the beams when selecting the width of each beam.

51. The method of claim 42, further comprising: using different modulation and coding combinations in the subcarrier groups.

52. The method of claim 42, further comprising: using a different modulation and coding combination in each subcarrier group.

53. The method of claim 42, further comprising: the angular velocity having a given variance around a mean value.

54. The method of claim 42, further comprising: the variance being zero.

55. The method of claim 42, further comprising: utilizing one or more specific beams for transmitting downlink control information.

56. A method, comprising:
utilizing multiple antenna beams in transmission,
dividing subcarriers of a multicarrier transmission into more than one subcarrier group,
allocating each subcarrier group to an antenna beam, and
controlling the antenna beams during transmission to sweep constantly over a given area at a constant mean beam specific angular velocity.

57. A base station, comprising an antenna arrangement configured to form multiple antenna beams, comprising:
a first controller configured to divide subcarriers of a multicarrier transmission into more than one subcarrier group and allocate each subcarrier group to an antenna beam, and
a second controller configured to control the antenna beams formed by the antenna arrangement during transmission to circulate around at a constant mean beam specific angular velocity.

58. The base station of claim 57, wherein the first controller is configured to divide the subcarriers of the multicarrier transmission into more than one subcarrier group on the basis of the number of different available modulation and coding combinations.

59. The base station of claim 57, wherein the first controller is configured to divide the subcarriers of the multicarrier transmission into more than one subcarrier group on the basis of transmission capacity and quality of service required by users served by the base station.

60. The base station of claim 57, wherein the first controller is configured to utilise channel quality information when selecting the number of different subcarrier groups.

61. The base station of claim 57, wherein the second controller is configured to control widths of the antenna beams beam-specifically.

62. The base station of claim 57, wherein the base station is configured to allocate users to the subcarriers on the basis of the transmission capacity and quality of service required by the users.

63. The base station of claim 16, wherein the base station is configured to allocate users to the subcarriers on the basis of the capabilities of user transceivers.

64. The base station of claim 57, wherein the second controller is configured to take into account interference level in a coverage area of the beams when selecting the angular velocity of each beam.

65. The base station of claim 61, wherein the second controller is configured to take into account interference level in a coverage area of the beams when selecting the width of each beam.

66. The base station of claim 57, wherein the base station is configured to use different modulation and coding combinations in the subcarrier groups.

67. The base station of claim 57, wherein the base station is configured to use a different modulation and coding combination in each subcarrier group.

68. The base station of claim 61, wherein the second controller is configured control the angular velocity to have a given variance around a mean value.

69. The base station of claim 62, wherein the base station is configured to send information about the subcarrier allocation to user transceivers.

70. The base station of claim 57, wherein the base station is configured to utilise one or more specific beams for transmitting downlink control information.

71. A base station, comprising an antenna arrangement configured to form multiple antenna beams, comprising:
a first controller configured to divide subcarriers of a multicarrier transmission into more than one subcarrier group and allocate each subcarrier group to an antenna beam, and
a second controller configured to control the antenna beams formed by the antenna arrangement during transmission to sweep constantly over a given area at a constant mean beam specific angular velocity.

72. A telecommunication system, comprising a base station utilizing an antenna arrangement configured to form multiple antenna beams, the base station comprising:
a first controller configured to divide subcarriers of a multicarrier transmission into more than one subcarrier group and allocate each subcarrier group to an antenna beam, and
a second controller configured to control the antenna beams during transmission to circulate around at a constant mean beam specific angular velocity.

73. A computer program distribution medium readable by a computer and encoding a computer program of instructions for a multicarrier data transmission, the transmission utilizing multiple antenna beams, the process comprising:
dividing subcarriers of the multicarrier transmission into more than one subcarrier group,
allocating each subcarrier group to an antenna beam, and
controlling the antenna beams during transmission to sweep constantly over a given area at a constant mean beam specific angular velocity.

74. The computer program distribution medium of claim 73, the distribution medium including at least one of the following media: a computer readable medium, a program storage medium, a record medium, a computer readable memory, a computer readable software distribution package, a computer readable signal, a computer readable telecommunications signal, and a computer readable compressed software package.

75. The computer program distribution medium of claim 73, the process further comprising controlling the angular velocity of the antenna beams to have a given variance around the mean value.

76. The computer program distribution medium of claim 73 the process further comprising controlling the antenna beams during transmission to circulate around at a constant mean beam specific angular velocity.

77. An integrated circuit, configured to
divide subcarriers of a multicarrier transmission into more than one subcarrier group and allocate each subcarrier group to an antenna beam,
control the antenna beams formed by an antenna arrangement during transmission to sweep constantly over a given area at a constant mean beam specific angular velocity.

78. The integrated circuit of claim 77, wherein the integrated circuit is configured to control the angular velocity to have a given variance around the mean value.

79. The integrated circuit of claim 77, wherein the integrated circuit is configured to control the antenna beams during transmission to circulate around at a constant mean beam specific angular velocity.

80. A user transceiver,
configured to receive information about subcarriers of multicarrier transmission allocated to the user transceiver and information about antenna beam control parameters controlling the antenna beams to sweep constantly over a given area at a constant mean beam specific angular velocity.

81. The user transceiver of claim 80, configured to estimate signal-to-noise ratios corresponding to future transmissions, and switch off reception until transmission with a suitable signal to noise ratio is expected.

82. A base station, comprising an antenna arrangement configured to form multiple antenna beams, comprising:
means for dividing subcarriers of a multicarrier transmission into more than one subcarrier group and allocating each subcarrier group to an antenna beam, and
means for controlling the antenna beams formed by the antenna arrangement during transmission to circulate around at a constant mean beam specific angular velocity.

83. A base station, comprising an antenna arrangement configured to form multiple antenna beams, comprising:
means for dividing subcarriers of a multicarrier transmission into more than one subcarrier group and allocating each subcarrier group to an antenna beam, and
means for controlling the antenna beams formed by the antenna arrangement during transmission to sweep constantly over a given area at a constant mean beam specific angular velocity.
